(19) United States
(12) Patent Application Publication
(10) Pub. No.: US 2026/0147669 A1
(43) Pub. Date: May 28, 2026

(54) MEMORY SYSTEM, MEMORY CONTROLLER, AND METHOD OF CONTROLLING NON-VOLATILE MEMORY

(71) Applicant: Kioxia Corporation, Tokyo (JP)

(72) Inventor: Yu SATO, Tokyo (JP)

(73) Assignee: Kioxia Corporation, Tokyo (JP)

(21) Appl. No.: 19/233,046

(22) Filed: Jun. 10, 2025

(30) Foreign Application Priority Data
Nov. 26, 2024 (JP) 2024-205130

(51) Int. Cl. G06F 11/10

(52) U.S. Cl. CPC G06F 11/1048; G06F 11/1016; G06F 11/1068

(57) ABSTRACT

In a memory system according to an embodiment, a controller determines first likelihood corresponding to first read information by using correspondence in which read information and likelihood are correlated with each other. The controller executes, for each of bits in the first read information, iterative processing of repeating soft-decision decoding including processing of determining posterior value likelihood until satisfying first or second termination condition. The controller executes preprocessing for update processing of the correspondence when satisfying the first termination condition. The controller executes the update processing using the posterior value likelihood after executing the preprocessing. The controller executes further the iterative processing after executing the update processing. The first termination condition represents that the number of repetitions of the soft-decision decoding in the iterative processing is equal to or greater than a first threshold. The second termination condition represents that the number of repetitions has reached a maximum value.

### CROSS-REFERENCE TO RELATED APPLICATIONS

This application is based upon and claims the benefit of priority from Japanese Patent Application No. 2024-205130, filed on Nov. 26, 2024, the entire contents of which are incorporated herein by reference.

### FIELD

Embodiments described herein relate generally to a memory system, a memory controller, and a control method.

### BACKGROUND

In a memory system, for protecting data stored in a memory such as a NAND flash memory, error-correction-encoded data is stored in the memory. When the data stored in the memory is read, the error-correction-encoded data that is read from the memory (also referred to as a received word) is decoded to restore data before the error correction encoding.

### BRIEF DESCRIPTION OF THE DRAWINGS

FIG. 1 is a block diagram of a memory system according to a first embodiment;

FIG. 2 is a diagram for explaining an example of an outer code and an inner code;

FIG. 3 is a diagram for explaining a configuration example of a code;

FIG. 4 is a block diagram of a decoder of the first embodiment;

FIG. 5 is a flowchart of decoding processing of the first embodiment;

FIG. 6 is a flowchart of determination processing of the first embodiment;

FIG. 7 is a diagram illustrating an example of decoding processing according to the first embodiment;

FIG. 8 is a flowchart of determination processing of a second embodiment; and

FIG. 9 is a diagram illustrating an example of decoding processing according to the second embodiment;

### DETAILED DESCRIPTION

A memory system according to an embodiment includes a non-volatile memory and a memory controller. The non-volatile memory is configured to store data and an error correction code generated by using the data. The memory controller is configured to read first read information from the non-volatile memory. The memory controller is configured to determine first likelihood information being a piece of likelihood information corresponding to the first read information among multiple pieces of likelihood information. The first likelihood information being determined by using correspondence information in which multiple pieces of read information and the multiple pieces of likelihood information are correlated with each other. The memory controller is configured to execute, for each of bits included in the first read information, iterative processing of repeating soft-decision decoding including processing of determining posterior value likelihood information by using the first likelihood information until a first termination condition or a second termination condition is satisfied. The memory controller is configured to execute preprocessing for update processing of updating the correspondence information when the first termination condition is satisfied. The memory controller is configured to execute the update processing by using the posterior value likelihood information acquired by the iterative processing after the preprocessing is executed or when the second termination condition is satisfied. The memory controller is configured to execute further the iterative processing after executing the update processing. The first termination condition represents that a value of an index indicating a degree of progress of decoding is stagnant compared with previous soft-decision decoding among soft-decision decoding steps repeatedly executed in the iterative processing, and the number of repetitions of the soft-decision decoding in the iterative processing is equal to or greater than a first threshold. The second termination condition represents that the number of repetitions has reached a maximum value.

The memory system according to the present embodiment will be described in detail with reference to the drawings. Note that the present invention is not limited by the following embodiments.

### First Embodiment

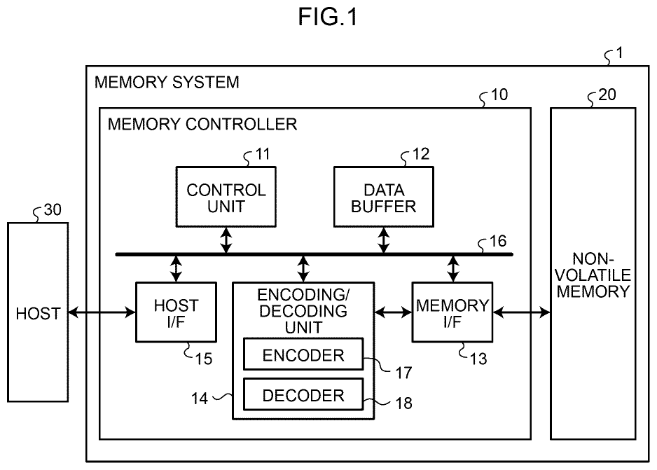

FIG. 1 is a block diagram illustrating a schematic configuration example of a memory system according to a first embodiment. As illustrated in FIG. 1, the memory system 1 includes a memory controller 10 and non-volatile memory 20. The memory system 1 can be connected to a host 30, and FIG. 1 illustrates the memory system 1 connected to the host 30. The host 30 may be, for example, an electronic device such as a personal computer or a mobile terminal.

Non-volatile memory 20 is a non-volatile memory that stores data in a non-volatile manner, and is, for example, NAND flash memory. Although a case where NAND memory is used as the non-volatile memory 20 will be exemplified in the following description, a storage device other than the NAND memory, such as three-dimensional structure flash memory, resistance random access memory (ReRAM), or ferroelectric random access memory (FeRAM), can be used as the non-volatile memory 20. The non-volatile memory 20 is not necessarily a semiconductor memory, and the present embodiment can also be applied to various storage media other than the semiconductor memory.

The memory system 1 may be a memory card or the like in which the memory controller 10 and the non-volatile memory 20 are configured as one package, or may be a solid state drive (SSD).

The memory controller 10 controls writing to the non-volatile memory 20 in accordance with a write request from the host 30. The memory controller 10 controls reading from the non-volatile memory 20 in accordance with a read request from the host 30. The memory controller 10 includes a host interface (host I/F) 15, a memory interface (memory I/F) 13, a control unit 11, an encoding/decoding unit (CODEC) 14, and a data buffer 12. The host I/F 15, the memory I/F 13, the control unit 11, the encoding/decoding unit 14, and the data buffer 12 are mutually connected by an internal bus 16. Some or all of operations of each component of the memory controller 10 may be implemented by a central processing unit (CPU) executing firmware or may be implemented by hardware.

The host I/F 15 is a circuit that performs processing according to an interface standard with the host 30, and outputs a command received from the host 30, user data to be written, and the like to the internal bus 16. The host I/F 15 transmits user data read from the non-volatile memory 20 and restored, a response from the control unit 11, and the like to the host 30.

The memory I/F 13 is a circuit that performs write processing to the non-volatile memory 20 based on an instruction from the control unit 11. The memory I/F 13 performs read processing from the non-volatile memory 20 based on the instruction from the control unit 11.

The control unit 11 integrally controls each component of the memory system 1. When a command is received from the host 30 via the host I/F 15, the control unit 11 performs control according to the command. For example, the control unit 11 instructs the memory I/F 13 to write the user data and a parity to the non-volatile memory 20 in accordance with a command from the host 30. In addition, the control unit 11 instructs the memory I/F 13 to read the user data and the parity from the non-volatile memory 20 in accordance with a command from the host 30.

When a user data write request is received from the host 30, the control unit 11 accumulates user data in the data buffer 12 and determines a storage area (memory area) for the user data in the non-volatile memory 20. That is, the control unit 11 manages a write destination of the user data. The correspondence between the logical address of the user data received from the host 30 and the physical address indicating the storage area on the non-volatile memory 20 storing the user data is stored as an address transformation table.

When a read request is received from the host 30, the control unit 11 transforms a logical address designated by the read request into a physical address by using the above-described address transformation table, and instructs the memory I/F 13 to perform reading from the physical address.

In the NAND memory, writing and reading are generally performed in data units called pages, and erasing is performed in data units called blocks. In the present embodiment, a plurality of memory cells connected to the same word line is referred to as a memory cell group. When the memory cell is a single level cell (SLC), one memory cell group corresponds to one page. When the memory cell is a multiple level cell (MLC), one memory cell group corresponds to a plurality of pages. Each memory cell is connected to the word line and is also connected to a bit line. Therefore, each memory cell can be identified by an address for identifying the word line and an address for identifying the bit line.

The data buffer 12 temporarily stores the user data received from the host 30 by the memory controller 10 until the user data is stored in the non-volatile memory 20. In addition, the data buffer 12 temporarily stores the user data read from the non-volatile memory 20 until the user data is transmitted to the host 30. As the data buffer 12, for example, general-purpose memory such as static random access memory (SRAM) or dynamic random access memory (DRAM) can be used.

The user data transmitted from the host 30 is transferred to the internal bus 16 and temporarily stored in the data buffer 12. The encoding/decoding unit 14 encodes the user data and generates a code word. In addition, the encoding/decoding unit 14 decodes a received word that is data read from the non-volatile memory 20, and restores the user data. Therefore, the encoding/decoding unit 14 includes an encoder 17 and a decoder 18. Note that the data encoded by the encoding/decoding unit 14 may include control data or the like used inside the memory controller 10 in addition to the user data.

Next, the write processing of the present embodiment will be described. The control unit 11 instructs the encoder 17 to encode the user data during user data writing to the non-volatile memory 20. At that time, the control unit 11 determines a storage location (storage address) of the code word in the non-volatile memory 20, and also instructs the memory I/F 13 on the determined storage location.

Based on the instruction from the control unit 11, the encoder 17 encodes the user data on the data buffer 12 and generates a code word. As the encoding method, for example, an encoding method using an algebraic code such as a Bose-Chaudhuri-Hocquenghem (BCH) code and a Reed-Solomon (RS) code, and an encoding method (product code or the like) using these codes as component codes in the row direction and the column direction can be employed. The memory I/F 13 performs control to store the code word in the storage location on the non-volatile memory 20 instructed from the control unit 11.

Next, processing during reading from the non-volatile memory 20 of the present embodiment will be described. The control unit 11 designates an address on the non-volatile memory 20 and instructs the memory I/F 13 to perform reading during reading from the non-volatile memory 20. In addition, the control unit 11 instructs the decoder 18 to start decoding. In accordance with the instruction of the control unit 11, the memory I/F 13 reads data from a designated address of the non-volatile memory 20, and inputs the read data as the received word to the decoder 18. The decoder 18 decodes the received word that is data read from the non-volatile memory 20.

Next, an error correction code (code word) used in the present embodiment will be described. In the present embodiment, the encoder 17 generates a concatenated code as the error correction code. The concatenated code is, for example, a code based on an error correction code C1 (first error correction code) generated by using data (user data) stored in the non-volatile memory 20 and an error correction code C2 (second error correction code) generated by using the error correction code C1. Hereinafter, the error correction code C1 is referred to as an outer code, and the error correction code C2 is referred to as an inner code.

The outer code is used for removing a remained error in a case where the correction cannot be made by error correction with the inner code. The outer code can be, for example, a BCH code capable of 4-bit correction. Since miscorrection occurs in decoding with the outer code (remained error removal), determination processing of determining whether or not miscorrection has not occurred may be executed. The inner code can be a multi-dimensional error correction code.

Here, the multi-dimensional error correction code refers to one in which a symbol, which is at least one constituent unit of the error correction code, is protected in a multiple manner by a plurality of smaller-scale component codes. One symbol includes, for example, one bit (element of a binary field) or an element of an alphabet such as a finite field other than the binary field. Hereinafter, for simplicity, a binary error correction code in which one symbol includes one bit will be described as an example. There may be parts where symbols and bits are mixed in the description, but both represent the same meaning.

An example of the multi-dimensional error correction code is a product code. The product code has, for example, a structure in which each information symbol that is a constituent unit of the user data is protected by a BCH code including a parity symbol of a predetermined parity length in each of a row direction and a column direction. That is, in the product code, all the symbols are doubly protected by component codes in the row direction (referred to as a dimension 1) and the column direction (referred to as a dimension 2). Note that the multi-dimensional error correction code is not limited thereto, and may be, for example, a generalized low density parity check code (GLDPC code) or the like. In the general multi-dimensional error correction code including the GLDPC code, the multiplicity of protection may be different for each symbol, and the component codes cannot be grouped into the dimension 1 and the dimension 2 or in other manners. However, the present technique can also be applied to such a code configuration.

Hereinafter, for simplicity, an example of using a two-dimensional error correction code (product code) in which each symbol is protected by two component codes that can be grouped into the dimension 1 and the dimension 2 will be described. Each component code of each dimension includes one or more component codes determined for each dimension. Hereinafter, a component code corresponding to each dimension including one or more component codes may be referred to as a component code group. For example, the component code group of the dimension 1 includes n1 component codes, and the component code group of the dimension 2 includes n2 component codes. The applicable error correction code is not limited thereto, and may be an N-dimensional error correction code in which at least one symbol among symbols constituting the code is protected by N (N is an integer of 2 or more) component code groups. When represented by the number of component codes included in each component code group, the N-dimensional error correction code is protected by M component codes (M is a sum of ni (1≤i≤N), N is an integer of 2 or more, and ni is the number of component codes of the i-th dimension).

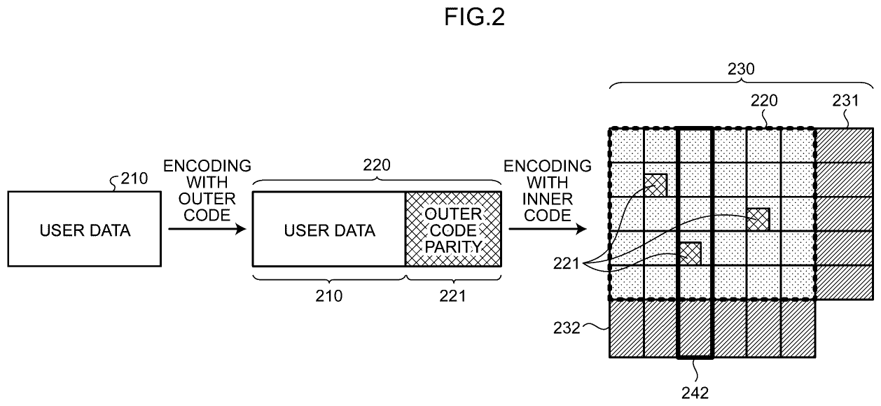

FIG. 2 is a diagram for explaining an example of the outer code and the inner code. Note that FIG. 2 illustrates an example in which a two-dimensional block product code including five blocks in the row direction and six blocks in the column direction is used as the inner code. Each block includes a plurality of symbols constituting the code. Each block corresponds to a symbol group that is a set of the plurality of symbols constituting the code. The number of blocks in each direction is not limited to the example illustrated in FIG. 2. In the drawings referred to hereinafter, a two-dimensional block product code including four blocks in each of the row direction and the column direction may be described as the inner code.

As illustrated in FIG. 2, the encoder 17 first encodes user data 210 to an outer code 220. The outer code 220 includes the user data 210 and an outer code parity 221. Next, the encoder 17 encodes the outer code 220 into the inner code 230. The inner code 230 includes the outer code 220, the parity 231 in the row direction of the inner code, and the parity 232 in the column direction of the inner symbol.

The inner code is, for example, a two-dimensional block product code having a BCH code capable of three-bit correction as the component code. In the example of FIG. 2, each of the five component codes in the row direction (dimension 1) and the six component codes in the column direction (dimension 2) is the BCH code capable of three-bit correction.

The outer code can be interpreted as mainly having the following roles.
Removal of an error (remained error) that cannot be corrected by the inner code
Determination as to whether an error remains in the user data: When no error remains, the outer code ends the processing as a decoding success.

The concatenated code in FIG. 2 can be decoded as follows.
(A1) Decoding with the inner code (product code) is executed. In the decoding of the product code, first, hard-decision decoding having a low correction capability but a high-speed operation is executed. The hard-decision decoding is decoding by using data of a hard-decision value, which is binary data of 0 or 1 read from the non-volatile memory 20. Hereinafter, the data of the hard-decision value may be referred to as hard bit data (HB data), and the hard-decision decoding may be referred to as HB decoding.
(A2) When the HB decoding is failed, soft-decision decoding having a speed operation lower than that of HB decoding but a high correction capability is executed. The soft-decision decoding is decoding by using likelihood information (such as a log-likelihood ratio) indicating the likelihood of 0 or 1. Hereinafter, the soft-decision decoding may be referred to as SB (soft bit) decoding.
(A3) When the decoding with the inner code is failed, decoding with the outer code is executed.

Since the inner code is a product code, decoding of the component code in the row direction (dimension 1) and the decoding of the component code in the column direction (dimension 2) may be repeatedly executed.

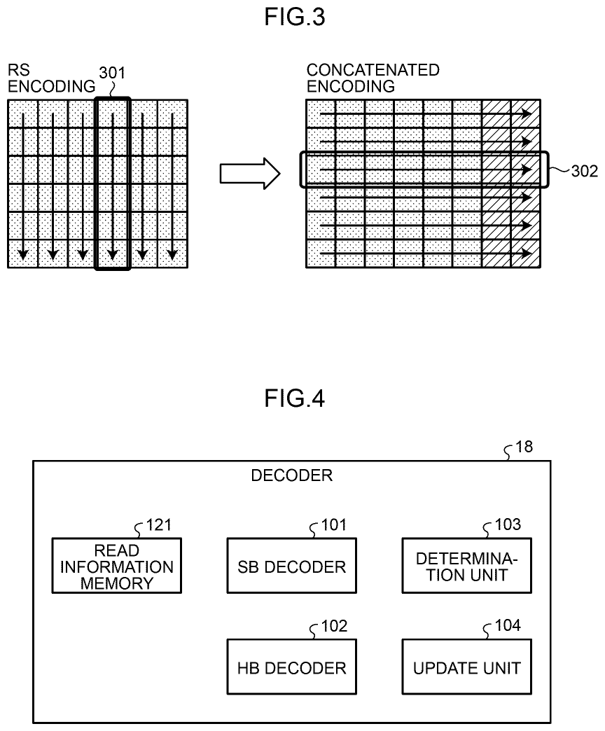

The concatenated code with the inner code and the outer code may be further protected by another code. FIG. 3 is a diagram illustrating an example of a configuration in which concatenation codes are protected by RS codes.

An RS frame 301 corresponds to a frame in which symbols are encoded by an RS code. When RS frames are arranged in the horizontal direction, a frame of the concatenated code (concatenated code frame) is obtained by encoding the symbols in a corresponding row of each of the RS frames with the concatenated code. A concatenated code frame 302 is an example of such a frame. The number of concatenated code frames (the number of rows) is not limited, and is about 70 to 140, for example.

The code in FIG. 3 can be decoded as follows.
(B1) Each concatenated code frame is decoded.
(B2) When decoding of a certain concatenated code frame is failed, decoding of all the concatenated code frames is executed for decoding with the RS code.
(B3) Re-decoding of the concatenated code frame that has failed to be decoded is executed by using the information obtained by decoding the concatenated code frames and the RS code.
(B4) Re-decoding is repeatedly executed until the decoding of the concatenated code frame that has failed to be decoded succeeds.

As described with reference to FIG. 2, SB decoding may be repeatedly executed for one concatenated code frame. In the configuration in which the re-decoding of the concatenated code frames is repeated as illustrated in FIG. 3, the number of executions of the SB decoding may further increase. That is, the overall latency of the decoding processing may increase. Therefore, to reduce the latency, it is desirable to provide a function of aborting the processing on a frame that fails to be SB-decoded without repeating the SB decoding (hereinafter, an aborting function).

On the other hand, the decoding processing may be configured to execute a function for improving the performance of the SB decoding (hereinafter, a performance improvement function) each time the SB decoding is repeated. For such a configuration, it is desirable to incorporate the aborting function such that the effect of the performance improvement function is not suppressed.

The memory system 1 of the present embodiment can reduce the latency while suppressing a degradation in the performance for error correction (decoding). The memory system 1 implements the aborting function such that aborting is not executed when the number of repetitions (the number of iterations) of SB decoding is small. In addition, when aborting is performed, the memory system 1 performs preprocessing necessary for the performance improvement function before the aborting.

Next, a configuration example of the decoder 18 of the present embodiment will be described. FIG. 4 is a block diagram illustrating a schematic configuration example of the decoder 18 of the first embodiment. As illustrated in FIG. 4, the decoder 18 includes a read information memory 121, an SB decoder 101, an HB decoder 102, a determination unit 103, and an update unit 104.

The read information memory 121 is implemented by, for example, SRAM. The SB decoder 101, the HB decoder 102, the determination unit 103, and the update unit 104 are implemented by at least one of a register, an adder, a multiplier, and other arithmetic units. The register is implemented by, for example, a logic circuit such as a flip-flop. The adder, the multiplier, a selector, and other arithmetic units are implemented by, for example, a logic circuit.

The read information memory 121 is memory that stores read information that is data read from the non-volatile memory 20.

Data of the read information representing a hard-decision value, which is binary information for identifying whether each bit is 0 or 1, corresponds to the above-described hard bit data. In addition, data of the read information corresponding to a part excluding the hard bit data may be referred to as soft bit data.

In the decoding process, data called a channel value may be required. The channel value indicates a value of a log-likelihood ratio (LLR) corresponding to a pair of the hard bit data and the soft bit data. The channel value may be referred to as channel LLR data. The channel value is determined by, for example, an LLR table in which the pair of the hard bit data and the soft bit data is correlated with the channel value. The channel value is an example of a soft-decision input value based on soft-decision read information read from the non-volatile memory 20. The LLR table corresponds to correspondence information in which pieces of read information (the pair of the hard bit data and the soft bit data) are correlated with pieces of likelihood information (log-likelihood ratio).

In reading by soft decision (soft bit reading), a piece of hard bit data and pieces of soft bit data are obtained. The one piece of hard bit data is obtained by using the same read voltage (hereinafter, referred to as VrH) as the read voltage used for reading by hard-decision (hard bit reading). In addition, the pieces of soft bit data are obtained by using read voltages including a read voltage having a value smaller than VrH and a read voltage having a value greater than VrH. The LLR table is, for example, a table in which the channel values are correlated for each pair of the one piece of hard bit data the pieces of soft bit data.

The SB decoder 101 executes SB decoding (soft-decision decoding) by using the read information. The SB decoder 101 determines, by using the LLR table, a corresponding channel value from the one piece of hard bit data and the pieces of soft bit data included in the read information. The SB decoder 101 executes decoding with the channel value as an input and outputs a soft-decision value (soft-decision output value) as a result. The soft-decision output value is, for example, a value obtained by expressing probability information indicating whether each bit is 0 or 1 in the form of LLR, and may be referred to as a posterior value (posterior value LLR).

As described above, the SB decoding includes processing of determining the channel value (first likelihood information) corresponding to the read information, by using the LLR table (correspondence information) for each of bits included in the read information (first read information) read from the non-volatile memory 20, and determining the posterior value LLR (posterior value likelihood information) by using the channel value.

In the present embodiment, the SB decoding may be repeated as in the product code in FIG. 2. That is, the SB decoder 101 repeatedly executes the SB decoding until the termination condition is satisfied. Hereinafter, the processing of repeating (iterating) the SB decoding may be referred to as iterative processing.

The HB decoder 102 executes HB decoding (hard-decision decoding) by using the read information. The HB decoder 102 executes decoding with the hard bit data as an input and outputs a hard-decision value as a result.

The HB decoder 102 executes the HB decoding as decoding to be executed before SB decoding of the product code, for example, as described in (A1) described above. The HB decoder 102 executes the HB decoding to determine whether the SB decoding has succeeded.

The determination unit 103 determines whether or not an termination condition of the iterative processing is satisfied. The termination condition includes, for example, the following termination condition CA (first termination condition) and termination condition CB (second termination condition).
Termination condition CA: A condition representing that the value of an index for the degree of progress of decoding is stagnant compared with the previous SB decoding among SB decoding steps repeatedly executed in the iterative processing, and the number of repetitions of the SB decoding is equal to or greater than a threshold THA (first threshold).
Termination condition CB: A condition representing that the number of repetitions has reached a maximum value.

The index used in the termination condition CA is, for example, the total number of bits for which the posterior value LLR has been determined to be equal to or greater than a threshold THB (second threshold). This total number may be referred to as MaxLLRCount. MaxLLRCount is, for example, a value calculated as in the following formula (1). Note that #{ } represents the number of elements in { }.

MaxLLRCount=#{|Bit satisfying posterior value LLR|≥threshold THB} (1)

As shown above, the posterior value LLR is a value representing the probability of whether the bit was originally 0 or 1, and is an inference value obtained from decoding processing. Therefore, a great absolute value of the posterior value LLR indicates that the reliability of the decoding result is high. Then, the condition that the absolute value of the posterior value LLR is equal to or greater than the threshold THB indicates that decoding is progressing successfully. Therefore, MaxLLRCount can be interpreted as representing the total number of bits for which the decoding is progressing successfully. MaxLLRCount is expected to increase monotonically with decoding. On the other hand, it can be determined that the stagnation of the value of MaxLLRCount means that the decoding of the frame to be decoded is stagnant (the frame fails to be decoded).

Note that stagnation of the value of MaxLLRCount means, for example, the stagnation of an increase in MaxLLRCount. The stagnation in the increase in MaxLLRCount means, for example, that the amount of increase in MaxLLRCount is equal to or less than a threshold THC (third threshold), or MaxLLRCount is decreasing.

The termination condition CA can be interpreted as a condition for implementing the aborting function described above. That is, the termination condition CA includes the stagnation of decoding as part of the condition for aborting. In the present embodiment, the termination condition CA further includes, as part of the condition for aborting, a condition that the number of repetitions of the SB decoding is equal to or greater than the threshold THA (first threshold). This condition corresponds to a condition for preventing the effect of performance improvement by the performance improvement function from being suppressed.

The update unit 104 executes update processing of updating the LLR table. The update processing is, for example, processing of estimating an LLR table more suitable for the channel by using the decoding result (posterior value LLR) obtained from the iterative processing of SB decoding, and updating an LLR table to be used in subsequent SB decoding by the estimated LLR table. The processing of estimating the LLR table may be implemented by any conventionally used method.

The update processing by the update unit 104 corresponds to the above-described performance improvement function. Note that the performance improvement function is not limited to the update processing of the LLR table, and may be any other function as long as the function improves the performance of the SB decoding.

Here, it is assumed that the update processing of the LLR table is executed as the performance improvement function, and the processing is simply aborted for a frame that fails to be SB-decoded. In such a configuration (as a comparative example), the estimation accuracy of the LLR table may decrease and the decoding performance may not be improved due to the following causes.
(C1) If aborting occurs when the number of repetitions is small, the reliability of data used for the estimation of the LLR table decreases.
(C2) The following processing executed in the second half of the iterative processing to improve the estimation accuracy of the LLR table is not executed by aborting.
Change the index in the log-prior probability ratio table
Hard-decision decoding with higher decoding performance

Therefore, the present embodiment includes the following functions (D1) and
(D2) to suppress the decrease in the estimation accuracy of the LLR table that can be caused by the above-described causes.
(D1) Set a threshold for the number of repetitions so as to prevent the aborting function from being executed when the number of repetitions of the iterative processing is small. When the number of repetitions is less than the threshold, aborting is not executed.
(D2) When executing aborting, perform preprocessing necessary for improving the estimation accuracy of the LLR table, which is to be performed in the second half of the iterative processing, before terminating the iterative processing.

The function (D1) is implemented by using the condition that is included in the termination condition CA and indicates that the number of repetitions is equal to or greater than the threshold THA. For the function (D2), processing executed in the second half of the iterative processing as stated in (C2) above is executed as preprocessing. In one example, when the condition for aborting, namely, the termination condition CA is satisfied, the preprocessing necessary for improving the accuracy of the update processing is executed. The preprocessing is executed by, for example, at least one of the SB decoder 101 and the HB decoder 102.

When the iterative processing is ended under the termination condition CA, the update unit 104 executes the update processing after the preprocessing is executed. When the iterative processing is ended under the termination condition CB, processing corresponding to the preprocessing is executed in the second half of the iterative processing. Therefore, when the termination condition CB is satisfied, the update unit 104 executes the update processing without executing the preprocessing separately from the iterative process.

After the update processing is executed, the decoder 18 further executes the iterative processing with the updated LLR table. By using the updated LLR table, the possibility of successful decoding can be increased.

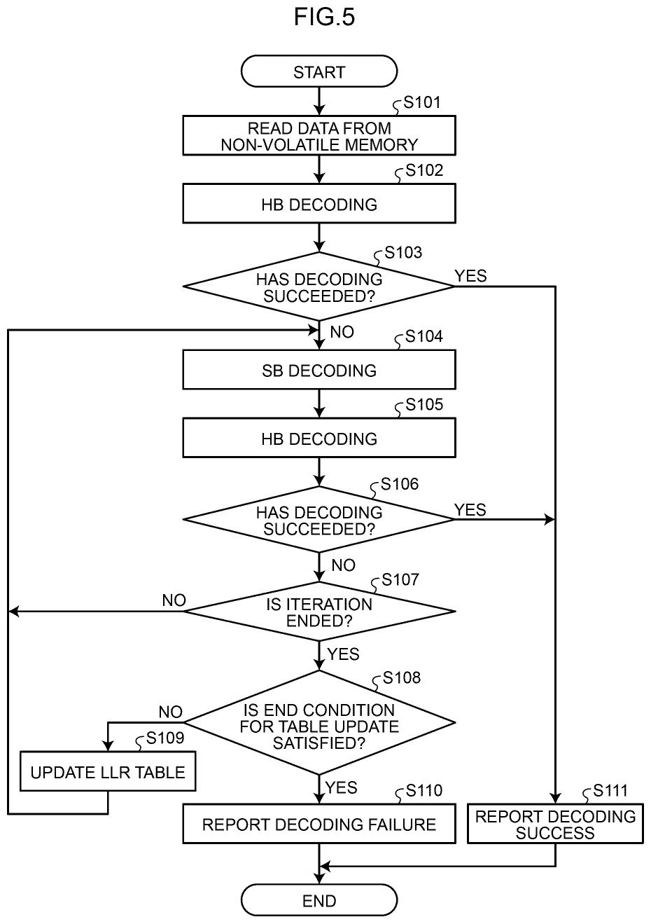

Next, a procedure of decoding processing by the memory system 1 of the present embodiment will be described. FIG. 5 is a flowchart illustrating an example of decoding processing of the first embodiment.

Note that the decoding processing of FIG. 5 is an example of decoding processing including iterative processing of repeating SB decoding. As described above, the iterative processing may be executed with a code having the configuration as illustrated in FIG. 2 or 3. The code on which the iterative processing is executed is not limited to those in FIG. 2 or FIG. 3, and may be any other code.

The control unit 11 reads the error correction code from the non-volatile memory 20, and obtains the received word (step S101). The control unit 11 transfers and stores the read information to the read information memory 121.

Next, the HB decoder 102 of the decoder 18 executes the HB decoding (step S102). The decoder 18 determines whether the decoding (HB decoding) has succeeded (step S103). If the decoding is failed (step S103: No), the SB decoder 101 of the decoder 18 executes the SB decoding (step S104).

The HB decoder 102 of the decoder 18 executes the HB decoding to determine whether the SB decoding is successful (step S105). Note that the determination as to whether the SB decoding is successful may be executed when a predetermined condition is satisfied. The predetermined condition is, for example, any of the following conditions.
The number of iterations is an even number.
The number of iterations is an odd number.
The number of iterations is a multiple of a predetermined integer.

The decoder 18 determines whether or not the decoding has succeeded, by using the result of the HB decoding in step S105 (step S106). If the decoding is failed (step S106: No), the determination unit 103 of the decoder 18 determines whether or not to end the iteration (step S107). Details of the determination processing by the determination unit 103 will be described later.

In response to determining not to end the iteration (step S107: No), the processing is repeated by returning to step S104. In response to determining to end the iteration in the determination processing (step S107: Yes), the determination unit 103 next determines whether or not the termination condition of the update processing of updating the LLR table (hereinafter, an termination condition CC) is satisfied (step S108). In one example, when the number of repetitions of the update processing reaches a predetermined upper limit value, the determination unit 103 determines that the termination condition CC is satisfied.

When the termination condition CC is not satisfied (step S108: No), the update unit 104 executes the update processing of the LLR table (step S109). After the update processing, the processing is repeated by returning to step S104.

When the termination condition CC is satisfied (step S108: Yes), the decoder 18 notifies the external control unit of a decoding failure (step S110), and ends the decoding processing.

In response to determining, in step S103 or step S106, that the decoding has succeeded (step S103: Yes, step S106: Yes), the decoder 18 notifies the external control unit of a decoded word together with the decoding success (step S111), and ends the decoding processing.

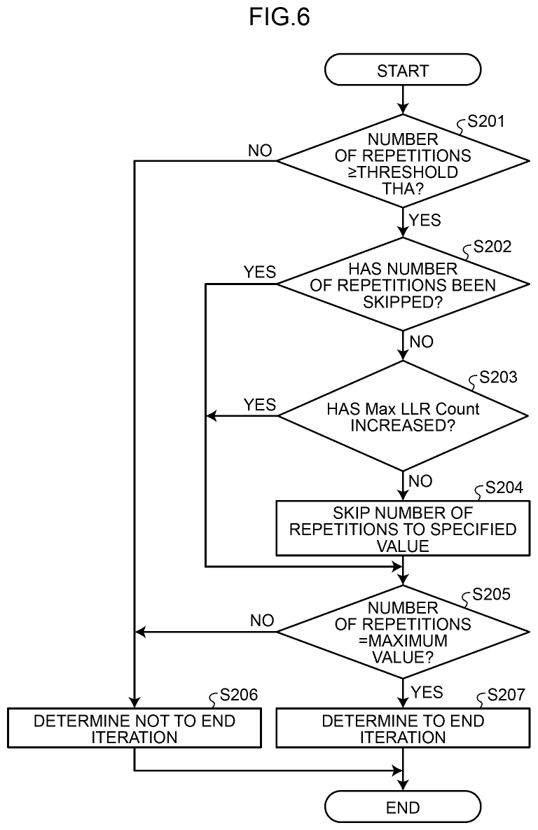

Next, details of the determination processing in step S107 will be described. FIG. 6 is a flowchart illustrating an example of the determination processing of the first embodiment.

The determination unit 103 determines whether or not the number of repetitions is equal to or greater than the threshold THA (step S201). When the number of repetitions is equal to or greater than the threshold THA (step S201: Yes), the determination unit 103 determines whether or not the number of repetitions has been skipped (step S202).

The skipping of the number of repetitions means skipping (increasing) the number of repetitions to a specified value in step S204 to be described later. Skipping the number of repetitions corresponds to aborting the iterative processing. The specified value is, for example, a value indicating the number of repetitions at which the execution of the preprocessing necessary for improving the estimation accuracy of the LLR table is started.

When the number of repetitions has not been skipped (step S202: No), the determination unit 103 determines whether or not MaxLLRCount has increased (step S203).

When MaxLLRCount has not increased (step S203: No), the determination unit 103 skips the number of repetitions to the specified value (step S204). Note that determining that MaxLLRCount has not increased in step S203 corresponds to satisfying the above-described termination condition CA.

In the example of FIG. 6, by skipping the number of repetitions to the specified value, the preprocessing necessary for improving the accuracy of the update processing can be executed during the SB decoding (step S104) or the HB decoding (step S105) included in the iterative processing of the number of repetitions from the specified value to the maximum value.

Note that the procedure of executing the preprocessing after terminating the decoding is not limited to the procedure of skipping the number of repetitions as illustrated in FIG. 6. For example, instead of skipping the number of repetitions, a procedure of executing the preprocessing after aborting the decoding and terminating the iterative processing (step S107: Yes) and before executing the update processing of the LLR table (step S109) may be used.

After the number of repetitions is skipped (step S204), when the number of repetitions has been skipped (step S202: Yes) and when MaxLLRCount has increased (step S203: Yes), the determination unit 103 determines whether or not the number of repetitions has reached the maximum value (step S205). Note that the determination in step S205 corresponds to determining whether or not the termination condition CB is satisfied.

When the number of repetitions has reached the maximum value (step S205: Yes), the determination unit 103 outputs a determination result indicating that the repetition is to be ended (step S206), and ends the determination processing.

In response to determining in step S201 that the number of repetitions is not equal to or greater than the threshold THA (step S201: No), and determining in step S205 that the number of repetitions has not reached the maximum value (step S205: No), the determination unit 103 outputs a determination result indicating that the repetition is not to be ended (step S206), and ends the determination processing.

Next, details of the preprocessing will be described. When the update processing of the LLR table is executed as the performance improvement function, the following processing described above in (C2) may be executed as the preprocessing.
Change the index in the log-prior probability ratio table
Hard-decision decoding with higher decoding performance

First, the index change of the log-prior probability ratio table will be described. The log-prior probability ratio is used for determining a decoding success rate. The decoding success rate is used for determining a maximum likelihood decoded word.

The log-prior probability ratio table is a table used for determining the log-prior probability ratio. The log-prior probability ratio table is, for example, a predetermined table in which an index is correlated with the log-prior probability ratio. The log-prior probability ratio tends to increase as decoding progresses. Therefore, a value that the number of repetitions of decoding is used as a key is set for the index.

On the other hand, when decoding is not progressing appropriately, a situation in which the log-prior probability ratio increases as the decoding progresses does not apply. Therefore, when the number of repetitions is around the maximum value, determination is made such that the decoding is not progressing appropriately, and the index is forcibly changed to a small value (the determined log-prior probability ratio is reduced). Such processing corresponds to the index change of the log-prior probability ratio table. This enables the decoding to be more accurately performed.

The change of the log-prior probability ratio table is executed during, for example, the SB decoding by the SB decoder 101. The number of repetitions reaches a specified value, the SB decoder 101 changes the log-prior probability ratio table and then executes the SB decoding. The specified value may be set in any manner, and is, for example, a value greater than half of the maximum value of the number of repetitions and equal to or less than the maximum value.

Next, hard-decision decoding with higher decoding performance will be described. The hard-decision decoding with higher decoding performance means hard-decision decoding with higher decoding performance than hard-decision decoding executed for other numbers of repetitions (for example, hard-decision decoding executed when the number of repetitions is less than the threshold THA). The hard-decision decoding with high decoding performance is, for example, decoding with a large allowable latency and decoding with an increased number of correctable bits.

The hard-decision decoding with higher decoding performance is executed as, for example, HB decoding executed by the HB decoder 102 during the iterative processing (step S105 in FIG. 5). In one example, when the number of repetitions reaches the specified value, the HB decoder 102 executes the hard-decision decoding with higher decoding performance.

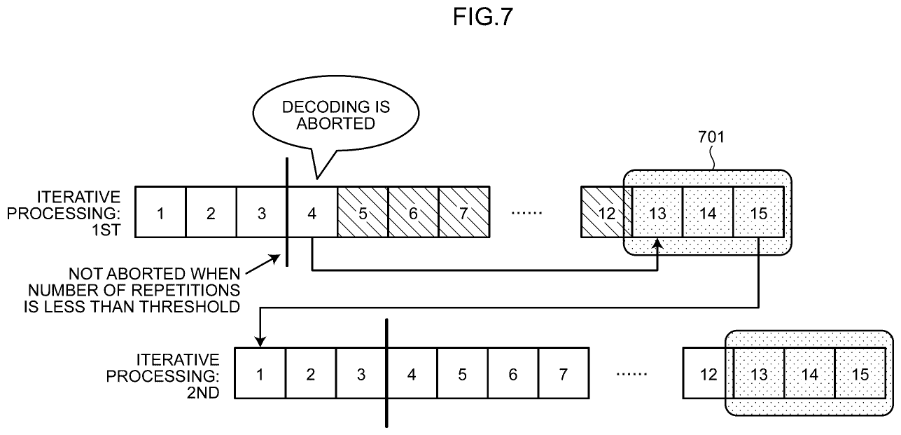

Next, an example of decoding processing according to the present embodiment will be described. FIG. 7 is a diagram illustrating the example of the decoding processing according to the present embodiment. FIG. 7 illustrates an example in which each parameter regarding the iterative processing is set as follows.
Maximum value of the number of repetitions: 15
Threshold THA: 4
Specified Value: 13

In the present embodiment, when the number of repetitions of the iterative processing is less than the threshold THA=4, aborting is not executed during the decoding even if the value of the index indicating the degree of progress of decoding (MaxLLRCount) is stagnant. When the number of repetitions is equal to or greater than the threshold THA=4 and the value of the index indicating the degree of progress of decoding (MaxLLRCount) is stagnant (termination condition CA), aborting is executed. In the example of FIG. 7, to execute the preprocessing executed in a second half 701 of the iterative processing, the number of repetitions is skipped to the specified value (=13).

After the processing in the second half 701 is executed, the update processing of the LLR table (step S109 in FIG. 6) is executed, and the next iterative processing (step S104 in FIG. 6) is further executed.

In the present embodiment, since the preprocessing for the update processing is executed, the accuracy of the update processing of the LLR table can be improved. As a result, in the next iterative processing, the possibility that the decoding progresses without stagnation can be increased by using the LLR table updated with high accuracy.

### Second Embodiment

If the SB decoding is failed, it is desirable to abort the iterative processing to suppress the increase in latency. The first embodiment described above includes the aborting function for such a purpose. On the other hand, when the SB decoding is successful, continuously repeating the SB decoding may be able to increase the possibility of the decoding success.

The second embodiment further includes a function of carrying over the number of repetitions reduced by the aborting function to the number of repetitions in the next iterative processing. This makes it possible to improve decoding performance while suppressing the increase in latency.

In the second embodiment, for example, when the repetition of the SB decoding is ended under the termination condition CA, the decoder 18 increases the maximum value of the number of repetitions to be used in the termination condition CB of the next iterative processing. By adding an integer of 1 or more, which is equal to or less than the reduced number (skipped number) of the number of repetitions of SB decoding when the repetition of SB decoding is ended under the termination condition CA, to the maximum value, the decoder 18 calculates the maximum value to be used in the termination condition CB of the next iterative processing. The reduced number can be calculated by, for example, “specified value-number of repetitions at aborting −1.” Since an integer equal to or less than the reduced number is added, it is possible to suppress the increase in latency in the entire decoding processing of repeating the iterative processes.

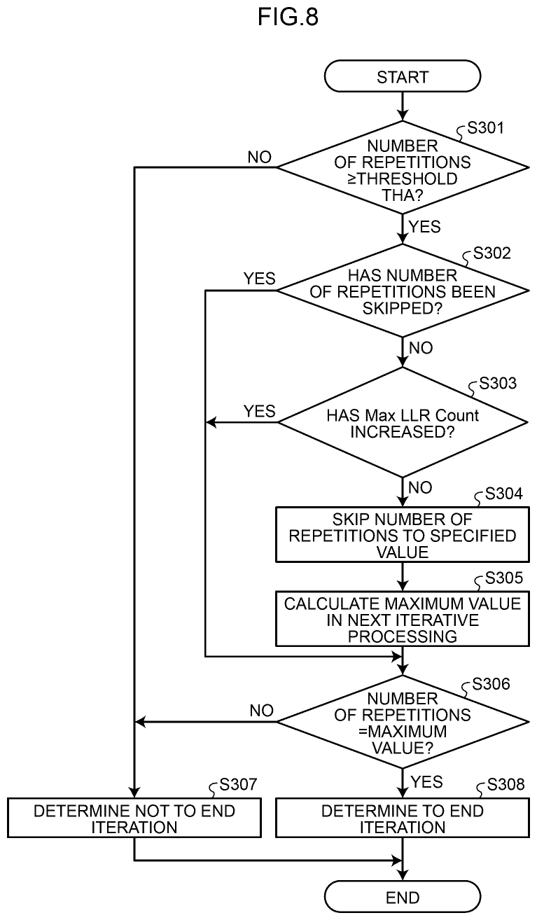

In the present embodiment, the determination processing by the determination unit 103 is different from that of the first embodiment. Hereinafter, an example of the determination processing in the present embodiment will be described. FIG. 8 is a flowchart illustrating an example of the determination processing of the second embodiment.

Since steps S301 to S304 are similar to steps S201 to S204 in FIG. 6 illustrating the determination processing of the first embodiment, the description thereof is omitted.

In the present embodiment, after skipping the number of repetitions to the specified value (step S304), the determination unit 103 calculates the maximum value of the number of repetitions for the iterative processing of next time (step S305). In one example, the determination unit 103 calculates the maximum value for the next iterative processing by adding the number of repetitions (reduced number) corresponding to the skipped number to the maximum value used in the current iterative processing. The calculated maximum value may be stored in a storage unit such as the data buffer 12.

In the next step S306, the determination unit 103 uses the maximum value of the number of repetitions calculated for the current iterative processing. When the current iterative processing ends (in FIG. 5, step S107: Yes) and the processing transitions to the next iterative processing, the determination unit 103 uses the maximum value calculated in step S305.

Note that, when the decoding is not skipped, the determination unit 103 may set the maximum value of the number of repetitions for the next iterative processing to a default value (for example, “15”). The determination unit 103 may be configured to use a value obtained by adding the reduced number in the previous iterative processing to the default value as the maximum value used in the current iterative processing.

Since steps S306 to S308 are similar to steps S205 to S207 in FIG. 6 illustrating the determination processing of the first embodiment, the description thereof is omitted.

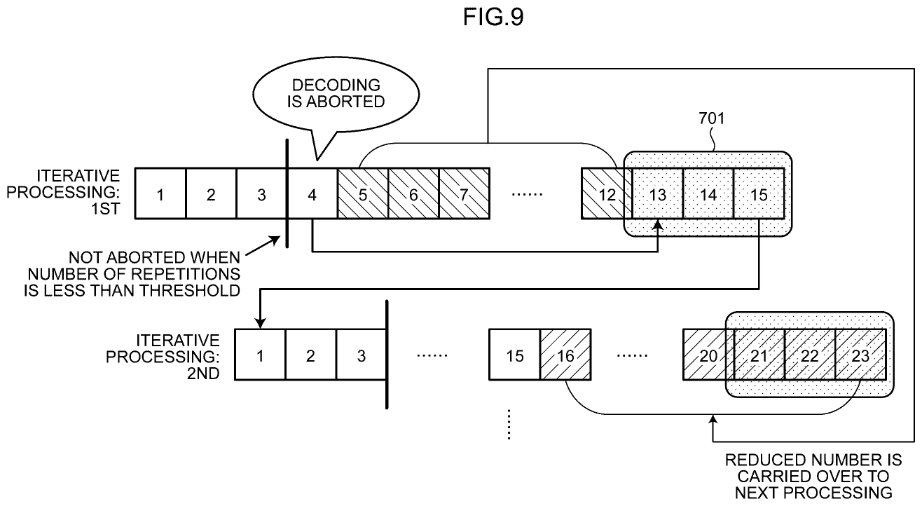

Next, an example of decoding processing according to the present embodiment will be described. FIG. 9 is a diagram illustrating the example of the decoding processing according to the present embodiment. FIG. 9 illustrates, as in FIG. 7, an example in which each parameter regarding the iterative processing is set as follows.
Maximum value of the number of repetitions: 15
Threshold THA: 4
Specified Value: 13

Assume that the decoding is aborted when the number of repetitions is four. In this case, the determination unit 103 calculates the value of 23 obtained by adding the reduced number of 8 (=the specified value of 13−the number of repetitions of 4−1) to the maximum value of 15 as the maximum value of the next iterative processing.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile memory configured to store data and an error correction code generated by using the data; and
a memory controller configured to
read first read information from the non-volatile memory,
determine first likelihood information being a piece of likelihood information corresponding to the first read information among multiple pieces of likelihood information, the first likelihood information being determined by using correspondence information in which multiple pieces of read information and the multiple pieces of likelihood information are correlated with each other,
execute, for each of bits included in the first read information, iterative processing of repeating soft-decision decoding including processing of determining posterior value likelihood information by using the first likelihood information until a first termination condition or a second termination condition is satisfied,
execute preprocessing for update processing of updating the correspondence information when the first termination condition is satisfied,
execute the update processing by using the posterior value likelihood information acquired by the iterative processing after the preprocessing is executed or when the second termination condition is satisfied, and
execute further the iterative processing after executing the update processing, wherein
the first termination condition represents that
a value of an index indicating a degree of progress of decoding is stagnant compared with previous soft-decision decoding among soft-decision decoding steps repeatedly executed in the iterative processing, and
the number of repetitions of the soft-decision decoding in the iterative processing is equal to or greater than a first threshold, and
the second termination condition represents that the number of repetitions has reached a maximum value.

2. The memory system according to claim 1, wherein the memory controller is configured to, when repetition of the soft-decision decoding is ended under the first termination condition, increase the maximum value to be applied to the second termination condition used for the iterative processing of next time.

3. The memory system according to claim 2, wherein the memory controller is configured to calculate the maximum value to be applied to the second termination condition used for the iterative processing of next time by adding, to the maximum value, an integer of 1 or more that is equal to or less than a reduced number of the number of repetitions of the soft-decision decoding when the repetition of the soft-decision decoding is ended under the first termination condition.

4. The memory system according to claim 1, wherein
the index indicating the degree of progress of decoding is a total number of bits for which the posterior value likelihood information has been determined to be equal to or greater than a second threshold, and
the first termination condition represents that increase in the total number is stagnant compared with the previous soft-decision decoding and the number of repetitions is equal to or greater than the first threshold.

5. The memory system according to claim 1, wherein
the iterative processing includes hard-decision decoding for determining whether the soft-decision decoding has succeeded, and
the preprocessing is hard-decision decoding with higher decoding performance compared with the hard-decision decoding executed when the number of repetitions is less than the first threshold.

6. The memory system according to claim 1, wherein the first termination condition represents that:
an increase amount of the total number of bits for which the posterior value likelihood information has been determined to be equal to or greater than the second threshold compared with the previous soft-decision decoding among the soft-decision decoding steps repeatedly executed in the iterative processing, is equal to or less than a third threshold, or
the total number decreases; and
the number of repetitions is equal to or greater than the second threshold.

7. The memory system according to claim 1, wherein the error correction code is an N-dimensional error correction code in which at least one symbol among symbols constituting the code is protected by N (N is an integer of 2 or more) component code groups.

8. A memory controller comprising:
a processor; and
a memory interface configured to connect the processor and a non-volatile memory in which data and an error correction code generated by using the data are stored, wherein
the processor is configured to
read first read information from the non-volatile memory via the memory interface,
determine first likelihood information being a piece of likelihood information corresponding to the first read information among multiple pieces of likelihood information, the first likelihood information being determined by using correspondence information in which multiple pieces of read information and the multiple pieces of likelihood information are correlated with each other,
execute, for each of bits included in the first read information, iterative processing of repeating soft-decision decoding including processing of determining posterior value likelihood information by using the first likelihood information until a first termination condition or a second termination condition is satisfied,
execute preprocessing for update processing of updating the correspondence information when the first termination condition is satisfied,
execute the update processing by using the posterior value likelihood information acquired by the iterative processing after the preprocessing is executed or when the second termination condition is satisfied, and
execute further the iterative processing after executing the update processing,
the first termination condition represents that
a value of an index indicating a degree of progress of decoding is stagnant compared with previous soft-decision decoding among soft-decision decoding steps repeatedly executed in the iterative processing, and
the number of repetitions of the soft-decision decoding in the iterative processing is equal to or greater than a first threshold, and
the second termination condition represents that the number of repetitions has reached a maximum value.

9. The memory controller according to claim 8, wherein the processor is configured to, when repetition of the soft-decision decoding is ended under the first termination condition, increase the maximum value to be applied to the second termination condition used for the iterative processing of next time.

10. The memory controller according to claim 9, wherein the processor is configured to calculate the maximum value to be applied to the second termination condition used for the iterative processing of next time by adding, to the maximum value, an integer of 1 or more that is equal to or less than a reduced number of the number of repetitions of the soft-decision decoding when the repetition of the soft-decision decoding is ended under the first termination condition.

11. The memory controller according to claim 8, wherein
the index indicating the degree of progress of decoding is a total number of bits for which the posterior value likelihood information has been determined to be equal to or greater than a second threshold, and
the first termination condition represents that increase in the total number is stagnant compared with the previous soft-decision decoding and the number of repetitions is equal to or greater than the first threshold.

12. The memory controller according to claim 8, wherein
the iterative processing includes hard-decision decoding for determining whether the soft-decision decoding has succeeded, and
the preprocessing is hard-decision decoding with higher decoding performance compared with the hard-decision decoding executed when the number of repetitions is less than the first threshold.

13. The memory controller according to claim 8, wherein the first termination condition represents that:
an increase amount of the total number of bits for which the posterior value likelihood information has been determined to be equal to or greater than the second threshold compared with the previous soft-decision decoding among the soft-decision decoding steps repeatedly executed in the iterative processing, is equal to or less than a third threshold, or
the total number decreases; and
the number of repetitions is equal to or greater than the second threshold.

14. The memory controller according to claim 8, wherein the error correction code is an N-dimensional error correction code in which at least one symbol among symbols constituting the code is protected by N (N is an integer of 2 or more) component code groups.

15. A method of controlling a non-volatile memory by a computer, the non-volatile memory storing data and an error correction code generated by using the data, the method comprising:
reading first read information from the non-volatile memory;
determining first likelihood information being a piece of likelihood information corresponding to the first read information among multiple pieces of likelihood information, the first likelihood information being determined by using correspondence information in which multiple pieces of read information and the multiple pieces of likelihood information are correlated with each other;
executing, for each of bits included in the first read information, iterative processing of repeating soft-decision decoding including processing of determining posterior value likelihood information by using the first likelihood information until a first termination condition or a second termination condition is satisfied;
executing preprocessing for update processing of updating the correspondence information when the first termination condition is satisfied;
executing the update processing by using the posterior value likelihood information acquired by the iterative processing after the preprocessing is executed or when the second termination condition is satisfied; and
executing further the iterative processing after executing the update processing, wherein
the first termination condition represents that
a value of an index indicating a degree of progress of decoding is stagnant compared with previous soft-decision decoding among soft-decision decoding steps repeatedly executed in the iterative processing, and
the number of repetitions of the soft-decision decoding in the iterative processing is equal to or greater than a first threshold, and
the second termination condition represents that the number of repetitions has reached a maximum value.

16. The method according to claim 15, further comprising
when repetition of the soft-decision decoding is ended under the first termination condition, increasing the maximum value to be applied to the second termination condition used for the iterative processing of next time.

17. The method according to claim 16, further comprising
calculating the maximum value to be applied to the second termination condition used for the iterative processing of next time by adding, to the maximum value, an integer of 1 or more that is equal to or less than a reduced number of the number of repetitions of the soft-decision decoding when the repetition of the soft-decision decoding is ended under the first termination condition.

18. The method according to claim 15, wherein
the index indicating the degree of progress of decoding is a total number of bits for which the posterior value likelihood information has been determined to be equal to or greater than a second threshold, and
the first termination condition represents that increase in the total number is stagnant compared with the previous soft-decision decoding and the number of repetitions is equal to or greater than the first threshold.

19. The method according to claim 15, wherein
the iterative processing includes hard-decision decoding for determining whether the soft-decision decoding has succeeded, and
the preprocessing is hard-decision decoding with higher decoding performance compared with the hard-decision decoding executed when the number of repetitions is less than the first threshold.

20. The method according to claim 15, wherein the first termination condition represents that:
an increase amount of the total number of bits for which the posterior value likelihood information has been determined to be equal to or greater than the second threshold compared with the previous soft-decision decoding among the soft-decision decoding steps repeatedly executed in the iterative processing, is equal to or less than a third threshold, or
the total number decreases; and
the number of repetitions is equal to or greater than the second threshold.
